(19) United States
(12) Patent Application Publication
(10) Pub. No.: US 2019/0233106 A1
(43) Pub. Date: Aug. 1, 2019

(54) Robotic Detector Test System

(71) Applicant: Tyco Fire & Security GmbH, Neuhausen am Rheinfall (CH)

(72) Inventors: Stephen Penney, Middlesex (GB); Timothy James, Middlesex (GB); Steven Bennett, Surrey (GB); Faruk Meah, Surrey (GB)

(21) Appl. No.: 16/340,028

(22) PCT Filed: Oct. 12, 2017
(86) PCT No.: PCT/EP2017/076133

§ 371 Date: Apr. 5, 2019

Related U.S. Application Data
(60) Provisional application No. 62/407,178, filed on Oct. 12, 2016.

(51) Int. Cl. B64C 39/02; G05D 1/10; G05D 1/00; B64F 3/02; B64D 47/08; G08B 29/14

(52) U.S. Cl. CPC B64C 39/024; G05D 1/101; G05D 1/0094; B64C 2201/12; B64D 47/08; G08B 29/145; B64C 2201/027; B64F 3/02

(57) ABSTRACT

The present invention relates to systems and methods for testing nodes within a fire detector system. The system comprises an aerial platform, such as a drone, and a base station in communication with the aerial platform and a fire control panel. The base station, in conjunction with the control panel, determines which of the nodes are to be tested and the aerial platform positions itself such that it is able to test the selected nodes.

### FIELD OF THE INVENTION

Embodiments of the present invention relate generally to a robotic detector test system. More specifically it relates to a mobile base station and aerial platform used, in combination, to test nodes in a detector system.

### BACKGROUND OF THE INVENTION

With a large service base and the requirement to regularly test the various parts of fitted fire detection systems, there is a large cost associated with sending service technicians to the various customer sites, with detectors in hard to reach places, presenting the service personnel with time consuming and hence costly challenges.

In current practice, a technician may visit many customer sites on a regular basis, requiring a considerable amount of travelling to carry out site testing with specialist test equipment. An operator controlled test drone has been proposed to simplify the service process; but this demands a high level of operator skill to correctly align the drone close to the ceiling where the airflow patterns can be disruptive to smooth flight.

US 2015/0246727 A1 discloses an aerial platform which is remotely controlled by an operator using a controller. The apparatus is used to service a detector of a first safety system. The apparatus includes a frame having a gas canister and a gas delivery cup attached thereto, and a drone attached to the frame which is capable of flying the frame under remote control by the operator. A gripping mechanism for gripping a portion of a detector is provided for servicing the detector.

Although US 2015/0246727 A1 also discloses that the aerial platform may be automatically directed toward a detector, problems still remain regarding the accurate location of detectors, distribution of control devices and the applicability to multiple detector types.

Embodiments of the present invention aim to overcome these problems by providing a system which is capable of reliably determining detector locations, improves control distribution and enables testing of multiple device types.

In an embodiment of the present invention:
Each customer may have a test arrangement present on that customer's site at all times;
The test arrangement may be automated such that no service technician is be required to visit;
Maintenance of the test system is sufficiently simple to be left to the customer or a local agent;
Servicing may be linked to system operation to ensure testing occurs at periods of low occupancy; and
Test data may be directly transmitted back to remote server for use in data analysis.

### SUMMARY OF THE INVENTION

In order to solve the problems associated with the prior art, the present invention provides a detector test system, comprising: a base station, configured to communicate with a fire control panel; an aerial platform, in communication with the base station; and a testing unit, detachably carried by the aerial platform, configured to test one or more nodes on a detector loop, wherein the base station is arranged to direct the aerial platform to carry the testing unit to the nodes to conduct one or more tests on the nodes.

The testing unit may be a first payload and the system may further comprise a second payload, wherein the first and second payloads are arranged to be detachably carried by the aerial platform, the first payload being different from the second payload.

The aerial platform may include an attachment means to which the first and second payloads can interchangeably be connected.

The base station may include a payload storage unit into which the payloads can be placed.

The base station may include a dock for carrying the aerial platform, and a carousel for interchanging the payloads on the aerial platform.

The base station may further comprise a movement control means, arranged to determine all of the movement of the aerial platform.

The movement control means may be arranged to determine an optimal flight path of the aerial platform, the flight path being based on the conduction of tests on at least two nodes.

The base station may further comprise a power supply, arranged to power all of the electrical components of the aerial platform.

The base station may further comprise a test unit control means, arranged to control the testing unit carried by the aerial platform.

The aerial platform may further comprise at least one light sensor and at least one processor, wherein, the processor may be further arranged to determine, based on a detection of a light signal from a node, that the node is in a test mode.

Upon determining that the node is in a test mode, the aerial platform may be instructed to proceed towards the node from which the light signal originates.

The at least one light sensor may be a camera.

The aerial platform may coupled to the base station by a cable, the cable transmitting at least one of: electrical power; and data signals.

A battery of the aerial platform may be located entirely within the base station.

A battery of the aerial platform may be located entirely within the aerial platform and wherein the base station is arranged to charge the battery.

According to a second aspect of the invention, a method of testing nodes in a detector loop, comprising the steps of: determining, by a base station in communication with a fire control panel, a first node to be tested, receiving, by the base station, an indication that the first node has entered a test mode; testing, by an aerial platform, the first node; and receiving, by the base station, an indication that the testing has been completed.

The method may further comprising the steps of: selecting, based on at least the determining, a first payload of a plurality of payloads; and attaching the first payload to the aerial platform.

The method may further comprise: determining, by the base station, a second node to be tested; receiving, by the base station, an indication that the second node has entered a test mode; selecting, based on the determination of the second node, a second payload of the plurality of payloads, interchanging the first payload with the second payload on the aerial platform; and testing, using the second payload carried by the aerial platform, the second node, wherein the first payload is different from the second payload.

The method may further comprise: determining, by the base station and based on the determination of the first node, a second node to be tested; and testing, using the aerial platform, the second node.

The method may further comprise: detecting, by a light sensor, a light signal being output by a detector; and determining, by a processor located on the aerial platform and based on the detection, that the node is in a test mode.

The method may further comprise, instructing, by the processor and based on the determining that the node is in a test mode, the aerial platform to proceed toward the node.

### BRIEF DESCRIPTION OF THE DRAWINGS

Other advantages and benefits of embodiments of the present invention will become apparent from a consideration of the following description and accompanying drawings, in which:

FIG. 1 shows an aerial platform configured for testing of a detector which is part of a detector loop, in accordance with the present invention.

### DETAILED DESCRIPTION OF EXEMPLARY EMBODIMENTS

Operating Concept

In one embodiment, the base station is manually placed in each zone to be tested in sequence, for example by a security guard during a period of low building occupancy. The base station having been downloaded with a map of call points (pull stations) and detectors (such as smoke, heat or CO2 or other toxic gas detectors) to be tested via a wireless link to the fire control panel then moves itself to each call point in turn and signals to the panel to isolate that call point before remotely operating it and receiving a signal back from the panel that it had been operated. The drone may have various mechanisms in order to operate/reset different call point types.

In order to perform the detector test function, an associated aerial platform may be loaded with an appropriate test source (such as smoke or CO2). The base station moves to a position under the detector before raising the aerial platform test system up to the detector under test. In an embodiment, the aerial platform part is tethered via power/control lines to the base station in order to avoid interference that is possible for a radio controlled system.

For conventional smoke detectors the test function uses an aerosol generated at the test platform and directed through a cylinder over the detector that forms a seal with the detector mounting surface. This ensures that the aerosol is directed correctly and that any draughts from the aerial platform lifting mechanism do not interfere with the test aerosol.

There are a number of other potential operating embodiments for each of the base station activities:

Mobility
Automatically moves
Path programmed in
Path autonomously determined
Able to autonomously open doors/use lifts (i.e., elevators)

Call Point Test
Call points (type and position) recognised
Test method programmed in (depends on type)
Test method autonomously determined

Communication with Fire Control Panel
Plugged in to a node;
Autonomously finds node;
Remote service station controls testing;
Panel controls regular testing;
Base station controls regular testing; and
Determines lowest occupancy for test.

For example, in some panels, a day/night mode can be specified by the customer and is set in the configuration. This does not necessarily correspond with real day or night, but with occupancy, where detector sensitivities are increased during low occupancy periods, (or decreased during high occupancy periods). As the panel has this programmed in, the software can use this to determine lowest occupancy. Alternatively it could be user programmed for when it is desirable to have the testing to occur.

Powered by
Battery/Fuel cell;
Rechargeable from mains (i.e., main power supply);
Manual connection;
Self initiated connection;
Autonomous self-initiated connection;
Programmed self-initiated connection; and
Dedicated Base station sockets.

Other Functions
Provides recharge station for detector tester(s);
Stores/replaces detector tester consumables.

Detector testers cannot carry large volumes of consumables, so in an embodiment the Base Station may act as a store/loading station for the consumables. When these are running low the Base Station may generate an automatic order for replenishment. (Consumables are items such as, but not limited to, Detector test aerosol, CO generator cartridges etc.);

Provides/Replaces Detector Batteries.

For example, a Detector Tester may land on a specific location (perhaps centred in place magnetically) where power probes can make contact with a charging socket, or alternatively the Tester can land where it can be temporarily latched in place and a mechanism in the Base Station exchanges a battery pack;
Provides programming updates for tester(s);
Able to reconfigure tester ‘type’ as necessary; and
Able to select appropriate tester platform for task.

Control System
Panel holds detector call point position map and transmits it to base station;
Radio/IR guidance to detector to be tested;
Provides updated detector location map;
Indicate detector under test (DUT) by illuminating it with laser/other light source;
Locally isolate DUT and verify operation during test;
Individual sounder check;
Sets detectors to ‘test’ mode during testing; and
Base station communicates with a remote ‘service’ control facility to instruct it.

Similarly there are potential embodiments of the aerial test platform and functions that it might perform:

Mobility
Microprocessor controlled to hold position accurately for testing
Path autonomously determined but able to locate and return to base station
Path programmed in
Path controlled directly by Base Station

Test Type Deployment
Carries/deploys appropriate test source for DUT
Test source type may be exchanged by the base station
Multiple aerial platforms carrying different test payloads managed by a single base station

Communicates with Base Station
Using radio/IR/control line
Notifies base station of test underway to enable point isolation
Monitors detector LEDs
Stores/communicates test information—time, test performed etc.
Identifies and communicates location of updates to building/detection system layout

Internal Features
Communicates self-diagnostics
Monitors power level to calculate return (if rechargeable)
Power is sufficient for several detector tests per ‘flight’
Power is obtained via wired ‘tether’ to Base Station

Test and Service Capabilities
Aerosol test for smoke detectors
Local heat test for heat detectors
Provide suitable test gasses for gas detectors
Multiple test sources to simultaneously test elements in multisensor detectors
Lock on and rotate to remove detector for battery replacement
IR/UV illumination for testing flame detectors
IR movement source for PIR detectors
(Partial) optical blocking source for beam detectors
Aerosol injection for aspirating detectors
Camera with pattern recognition for monitoring for detector damage
Local sensors for monitoring temperature, relative humidity, sound pressure level, etc.

Control
Guided by Base Station
Guided by codes/markings on DUT
Guided by separate ‘path’ markers (UV paint, magnetic strips, etc.)
Follows predetermined path
Able to recognise building features
Able to optimise from several different control means.

The base station may be a motorized trolley of sufficient height to be able to easily access call points and is able to perform various functions such as storage and control of aerial platform etc.

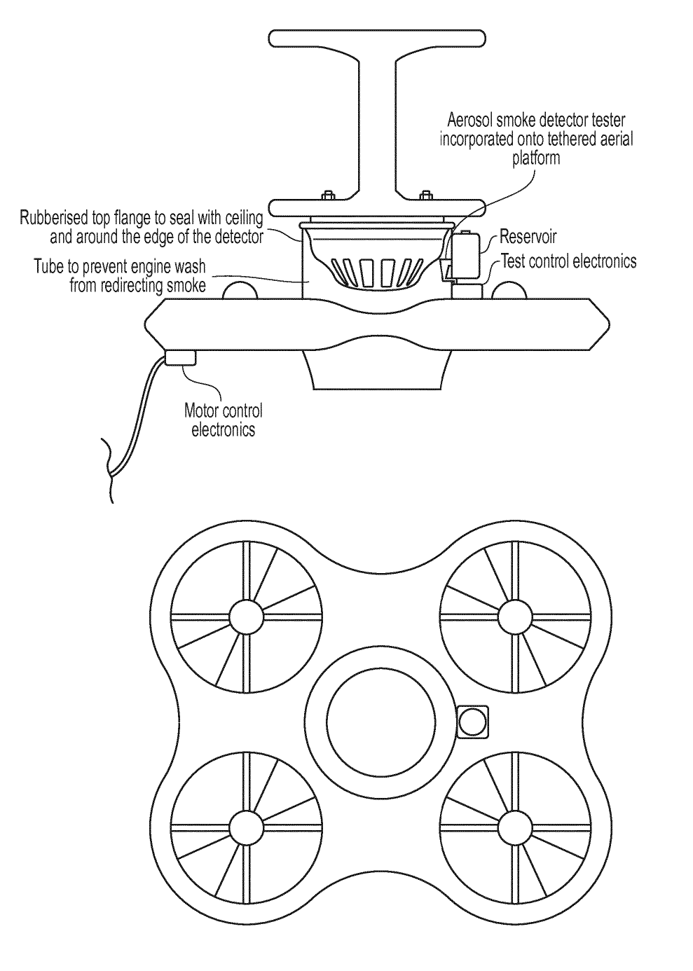

A robotic detector test system in accordance with an exemplary embodiment of the present invention is shown in FIG. 1.

An aerial platform comprises a quadcopter, or some other form of drone capable of remaining stationary in flight, such as a hectocopter or an octocopter. The platform must be capable of remaining stationary during flight, such that it is capable of performing a test procedure upon a detector node (such as a fire alarm, a smoke alarm, a call point etc.).

The platform further comprises a tube, which extends upward centrally from the platform. The tube is arranged to surround a detector node during a test procedure, such that air turbulence from the blades of the aerial platform does not inhibit the test procedure. An upper flange of the tube is rubberised so as to provide a seal around the detector during the test procedure.

The aerial platform also carries a payload, the payload being in communication with an inner volume of the tube, when attached to the aerial platform. The payload is detachably carried by the aerial platform, such that a payload having one type of testing equipment (or testing unit) can be exchanged for a payload having another type. Thus, different testing equipment can be presented to detector nodes, depending on the specific node to be tested. For example, the payload may comprise storage unit such as a a gas canister storing a test gas or aerosol (such as Carbon Monoxide, Hydrogen or Acetylene, or a fluid to be aerosolised to simulate smoke), a heat source or some other form of testing equipment arranged to trigger an alarm in a detector. The components of the payload (i.e. a testing unit and a storage unit) may be integrally formed or separately formed.

The aerial platform also comprises control electronics (or control means). The control electronics are used to control actuation of the payload and/or control movement of the aerial platform, such that the control electronics comprises test unit control means and movement control means. The control electronics can be arranged to actuate the payload in several ways. For example, the payload may be electrically actuated and, as such, the control electronics can be in electrical connection with the payload to provide such actuation. Alternatively, the payload may require physical actuation and, in this case, the control electronics can be electrically connected to a physical actuator. The control means also comprises a transceiver in order receive a signal indicating that the payload should be actuated and send a signal confirming that the actuation has occurred. Alternatively, the control means may comprise a receiver only, if a confirmation signal is not required.

In an embodiment of the invention, the payload is detachably attached to the testing unit of the aerial platform using an attachment means. In this manner, the payload can be removed and replaced with a different payload if, for example, a different type of test procedure is to be performed and/or a different type of node is to be tested. The payload may be attached in a variety of ways. For example, in one embodiment, the payload is attached magnetically to the aerial platform. In this manner, the attachment means comprises an electromagnet, which is activated and deactivated in order to hold and release the payload respectively. In this embodiment, the payload comprises, at least partially, a magnetic material such that when the electromagnet is active, the payload is attached to the aerial platform securely enough to prevent accidental detachment of the payload from the aerial platform. In another example, the payload is attached to the aerial platform using a mechanical attachment means. This may take the form of a mechanically actuated clip or a holding means such as a claw or gripping device. In another example, the payload is simply placed in a cup-like holder attached to the aerial platform. In this manner, the payload may be lifted in to and out of the holder, without need of any form of actuation to detach the payload.

The aerial platform further comprises motor control electronics. The motor control electronics are arranged to control the motor(s) of the aerial platform such that the aerial platform is capable of reaching and performing tests at detector nodes. The motor control electronics comprise a receiver arranged to receiver control signals for controlling the motor(s) of the aerial platform. The signals may be received from the control electronics on the aerial platform or from the base station.

The robotic detector test system of the present invention also comprises a base station. The base station is arranged to act as a docking area for the aerial platform when it is not in flight. The base station is mobile, such that the base station, with the aerial platform, can be located in the vicinity of one or more detector nodes before the aerial platform begins any test procedures. Alternatively, the base station is not mobile, but there is a base station located in each area in which nodes are to be tested.

In order to charge the aerial platform, the base station comprises a battery, which is arranged to charge a battery of the aerial platform when it is connected (e.g. docked) to the base station. Alternatively, the base station is connected to a mains power supply, which charges the battery of the aerial platform. In a further alternative, the base station comprises a battery and is capable of being connected to a mains power supply.

The base station also comprises a payload storage unit. The payload storage unit houses a plurality of payload types which may be required by the aerial platform to perform a test procedure. The base station is arranged to detach payloads from the aerial platform, place them in the payload storage unit, and then locate a required payload to be attached to the aerial platform. The payload storage unit may, for example, comprise a carousel of payload units, such that the base station can manipulate the carousel to place the desired payload unit a location for removing from the payload storage unit and attaching to the aerial platform.

In order to perform the charging and payload-switching functions described above, the base station comprises one or more docks. In one embodiment, the base station comprises a single dock. The dock further comprises means of charging the aerial platform. For example, the charging means may be electrical contact points, such that when the aerial platform lands, the contact points create an electrical circuit which enables charging of the aerial platform. Alternatively, the charging means may be a wireless charger. In this embodiment, dock also comprises means of attaching and detaching payloads. For example, the dock may have access to the payload storage unit from which a payload can be removed and attached to the aerial platform.

In an alternative embodiment, the base station comprises several docks. In this embodiment, the base station comprises a plurality of charging docks, upon which one or more aerial platforms may reside when not in use. The base station also comprises a payload switching dock such that, when an aerial platform is required, it repositions itself from the charging dock to the payload switching dock before receiving a payload.

The base station is in communication with a fire panel of a fire alarm system of which the detector nodes are a part. The base station is also in communication with the aerial platform. In this manner, the base station acts as a central control point for a plurality of test procedures to be performed by the aerial platform. The base station comprises one or more transceivers in order to communicate with the fire panel and the aerial platform wirelessly.

In an alternative embodiment, the aerial platform is connected to the base station by a tether. The tether is arranged to house power and/or communication cables.

In this manner, if electrical power is sent to the aerial platform using the tether, the aerial platform need not contain a battery, which reduces the weight of the aerial platform. Further, if electrical signals are sent to the aerial platform using the tether, the aerial platform need not have any signal transmitting or receiving means attached thereto and control means (such as the motor control electronics and the control electronics) can be placed in the base station.

In one embodiment, in order that the aerial platform is removed of unnecessary weight, all of the control means may be located within the base station. In this manner, the direction of flight of the aerial platform is determined at the base station and instructions are sent to the motor control electronics to perform a certain manoeuvre at the aerial platform, such as flying upwards toward a detector node. Similarly, the control electronics for controlling actuation of the payload may be located in the base station, with an actuator on the aerial platform receiving a signal from the base station, originating from the control electronics, to actuate the payload. The control signals may be sent wirelessly or via a tether, as discussed above.

As an example, the mobile base station and the aerial platform can be located in a room which contains a plurality of detector nodes (smoke alarms, fire alarms, call points etc.). The base station, in communication with the fire alarm panel, selects a node to be tested, for example, a first smoke alarm. The base station then attaches a payload, corresponding to the testing procedure of the first smoke alarm, to the aerial platform. The aerial platform is then directed, by the base station, to the location of the first smoke alarm and proceeds to that location. Once the aerial platform arrives at the location of the first smoke alarm, it locates itself such that the tube surrounds the smoke alarm. Once in position, the aerial platform transmits a ‘ready’ signal to the base station to confirm. Upon receipt of the ready signal, the base station communicates with the fire panel to cause the first smoke alarm to enter a test mode. Once the first smoke alarm has entered the test mode, the base station sends an actuation signal to aerial platform to cause it to actuate the payload and begin the test procedure. Once the test procedure has been completed, the aerial platform sends a completion signal to the base station which, in turn, communicates with the fire panel to take the first smoke alarm out of the test mode. The base station then communicates with the fire panel to select the next node to be tested. If the next node is a second smoke alarm requiring the same payload already attached to the aerial platform, then the aerial platform is simply directed to the second smoke alarm. However, if the next node requires a different payload to that which is already attached to the aerial platform, the aerial platform is recalled in order to exchange payloads.

Obviously, the steps described in the above example may be performed in a different order, depending on the specific embodiment. For example, the smoke alarm may be placed in a test mode before the aerial platform is directed to fly toward the node.

In order to deliver a payload to a detector node, a flight path must be determined for the aerial platform. The flight path may be determined in a number of different ways. In one embodiment, the flight path is determined based on an existing map of the area in which one or more detector nodes reside. In this manner, the base station may store, on a memory, a plurality of maps, each map containing information regarding the objects permanently positioned in the area, including the detector nodes. Once a determination has been made as to the node(s) to be tested, an optimal flight path for the aerial platform can be calculated, either at the base station or at the aerial platform. Such a flight path can include the need for returning to the base station for recharging, if multiple detector nodes are to be tested.

In an alternative embodiment, a flight path is determined ‘on the fly’ by the aerial platform. It is common for a fire or smoke alarm to comprise an LED (or other light source) which, when the node enters a test mode, flashes in order to confirm that the test mode has been entered. In this embodiment, the aerial platform further comprises a camera. In this manner, upon detection of the LED test signal from the node, the aerial platform (or the base station) calculates a path to the detector node and the aerial platform travels to it. In this embodiment, the aerial platform may also use the camera to detect obstructions between the detector node and itself. The processor required to perform the features of this embodiment (i.e. a light signal processor) may be located at the aerial platform or at the base station. For example, in the embodiment in which the light signal processor is located at the aerial platform, upon determination that a node is in a test mode, the processor may direct this information to the base station or use it to direct the aerial platform locally. If the information is sent to the base station, the control means located at base station may subsequently instruct the aerial platform to fly toward the specific node. If the information is used locally, within the aerial platform, the light signal processor can direct the information to control means, aboard the aerial platform, for determination of a flight path.

In embodiments in which the aerial platform comprises a camera, the camera can be used to inspect detector nodes. In this manner, the aerial platform can take simple images or recordings of the platform upon approach, in order that they can be inspected later by a human. Alternatively, the images or recordings can be compared to an ideal image or recording in order to determine whether damage has occurred or the node is dirty. If a node is considered to be damaged or dirty, it can be scheduled for repair or replacement by a human or by the aerial platform itself.

It is to be appreciated that signals transmitted by the base station or the aerial platform may be electrical, or alternatively, there may be a transmitter and a receiver arrangement, such that the information may be sent via Bluetooth®, RF signal, WiFi® or any other type of wireless transmission means.

The skilled person will also realise that steps of various above-described methods can be performed by programmed computers. Accordingly the above-mentioned embodiments should be understood to cover storage devices containing machine-executable or computer-executable instructions to perform some or all of the steps of the above-described methods. The embodiments are also intended to cover computers programmed to perform the steps of the above-described methods.

The functionality of the elements described above can be provided using either dedicated hardware and/or software. The expressions “processing”, “processing means” and “processing module” can include, but is not limited to, any of digital signal processor (DSPs) hardware, network processors, application specific integrated circuits (ASICs), field programmable gate arrays (FPGAs), read only memories (ROMs) for storing software, random access memories (RAMs), and non-volatile storage.

The above embodiments describe one way of implementing the present invention. It will be appreciated that modifications of the features of the above embodiments are possible within the scope of the independent claims. For example, the methods described herein may be applied to any kind of window. The features of the browser windows and web windows described herein are for example only and should not be seen as limiting to the claimed invention.

Features of the present invention are defined in the appended claims. While particular combinations of features have been presented in the claims, it will be appreciated that other combinations, such as those provided above, may be used.

1. A detector test system, comprising:
a base station, configured to communicate with a fire control panel;
an aerial platform, in communication with the base station; and
a testing unit, detachably carried by the aerial platform, configured to test one or more nodes on a detector loop,
wherein the base station is arranged to select a node to be tested,
wherein the base station is arranged to direct, based on the selection, the aerial platform to carry the testing unit to the selected node to conduct one or more tests on the node, and
wherein the base station includes a dock for carrying the aerial platform.

2. The detector test system according to claim 1, wherein the testing unit is a first payload and the system further comprises a second payload, wherein the first and second payloads are arranged to be detachably carried by the aerial platform, the first payload being different from the second payload.

3. The detector test system according to claim 2, wherein the aerial platform includes an attachment means to which the first and second payloads can interchangeably be connected.

4. The detector test system according to claim 2, wherein the base station includes a payload storage unit into which the payloads can be placed.

5. The detector test system according to claim 2, wherein the base station includes a carousel for interchanging the payloads on the aerial platform.

6. The detector test system, according to claim 1, wherein the base station further comprises a movement control means, arranged to determine all of the movement of the aerial platform.

7. The detector test system according to claim 6, wherein the movement control means is arranged to determine an optimal flight path of the aerial platform, the flight path being based on the conduction of tests on at least two nodes.

8. The detector test system, according to claim 1, wherein the base station further comprises a power supply, arranged to power all of the electrical components of the aerial platform.

9. The detector test system, according to claim 1, wherein the base station further comprises a test unit control means, arranged to control the testing unit carried by the aerial platform.

10. The detector test system according to claim 1, wherein the aerial platform further comprises at least one light sensor and at least one processor, and
wherein, the processor is further arranged to determine, based on a detection of a light signal from a node, that the node is in a test mode.

11. The detector test system according to claim 10, wherein, upon determining that the node is in a test mode, the aerial platform is instructed to proceed towards the node from which the light signal originates.

12. The detector test system according to claim 10, wherein the at least one light sensor is a camera.

13. The detector test system according to claim 1, wherein the aerial platform is coupled to the base station by a cable, the cable transmitting at least one of: electrical power; and data signals.

14. The detector test system according to claim 13, wherein a battery of the aerial platform is located entirely within the base station.

15. The detector test system according to claim 8, wherein a battery of the aerial platform is located entirely within the aerial platform and wherein the base station is arranged to charge the battery.

16. A method of testing nodes in a detector loop, comprising the steps of:
determining, by a base station in communication with a fire control panel, a first node to be tested,
receiving, by the base station, an indication that the first node has entered a test mode;
directing, by the base station, an aerial platform to the first node;
testing, by the aerial platform, the first node; and
receiving, by the base station, an indication that the testing has been completed.

17. The method of testing nodes in a detector loop in accordance with claim 16, further comprising the steps of:
selecting, based on at least the determining, a first payload of a plurality of payloads; and
attaching the first payload to the aerial platform.

18. The method of testing nodes in a detector loop according to claim 16, wherein the method further comprises:
determining, by the base station, a second node to be tested;
receiving, by the base station, an indication that the second node has entered a test mode;
selecting, based on the determination of the second node, a second payload of the plurality of payloads,
interchanging the first payload with the second payload on the aerial platform; and
testing, using the second payload carried by the aerial platform, the second node,
wherein the first payload is different from the second payload.

19. The method of testing nodes in a detector loop according to claim 16, wherein the method further comprises:
determining, by the base station and based on the determination of the first node, a second node to be tested; and
testing, using the aerial platform, the second node.

20. The method of testing nodes in a detector loop according to claim 16, wherein the method further comprises:
detecting, by a light sensor, a light signal being output by a detector; and
determining, by a processor located on the aerial platform and based on the detection, that the node is in a test mode.

21. The method of testing nodes in a detector loop according to claim 20, wherein the method further comprises, instructing, by the processor and based on the determining that the node is in a test mode, the aerial platform to proceed toward the node.
